(19) United States
(12) Patent Application Publication
(10) Pub. No.: US 2008/0270176 A1
(43) Pub. Date: Oct. 30, 2008

(54) METHOD, APPARATUS AND COMPUTER PROGRAM PRODUCT FOR ADJUSTING A QUANTITY OF AN ITEM SUPPLIED IN PREPARATION FOR A MEDICAL PROCEDURE

(75) Inventors: Darla D. Andersen, Lincoln, NE (US); Sara Strabala Peper, Roseville, MN (US); Nancy Christen, Minneapolis, MN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Corporation

(21) Appl. No.: 11/741,374

(22) Filed: Apr. 27, 2007

(51) Int. Cl. G06F 17/00

(52) U.S. Cl. 705/2

(57) ABSTRACT

A method, apparatus and computer program product are provided to update surgeon preference cards or similar records. In this regard, one or more instances may be identified in which the quantity of an item utilized during the medical procedure differed from the predefined quantity of the item supplied in preparation for the medical procedure. For example, the quantity of the item that was utilized most frequently during the medical procedure may be compared to the predefined quantity of the item. An adjustment to the predefined quantity of the item may then be determined if the quantity of the item that was actually utilized most frequently differed from the predefined quantity of the item. A recommendation can then be provided that the predefined quantity of the item be altered in accordance with the adjustment. Based on user response, the predefined quantity of the item may be altered.

### FIELD OF THE INVENTION

Embodiments of the present invention relate generally to the identification of items necessary for the performance of a medical procedure and, more particularly, to the adjustment of the quantity of an item supplied in preparation for a medical procedure.

### BACKGROUND OF THE INVENTION

Each medical procedure generally requires a set of supplies, such as gauze, clamps and the like. While not every medical procedure requires a different set of supplies, many medical procedures do require a unique set of supplies, either in quantity of an item, type of items or both. The set of supplies required for a particular medical procedure is further complicated since each surgeon that performs the medical procedure requires his or her own set of supplies. While some surgeons may utilize a common set of supplies to perform the same medical procedure, other surgeons may utilize different sets of supplies to perform the same procedure. For example, a first surgeon may perform a medical procedure and use six clamps, while a second surgeon may perform the same medical procedure and require eight clamps.

As will be apparent, it is important to have the correct supplies on hand for each medical procedure with the set of supplies being tailored in accordance with the requirements of the surgeon performing the medical procedure. In this regard, it is important to have the proper quantity of each item required by the surgeon for the medical procedure since the provision of too few of any item may undesirably delay the surgery while additional ones of the item are located, while the provision of too many of any item will have unnecessarily required the withdrawal of the surplus items from inventory and will further require either the restocking or disposal of the surplus items.

In order to define the number and type of items required for each medical procedure performed by each surgeon, surgeon preference cards, also known as resource maps, are maintained. In this regard, a surgeon preference card identifies the type of items and the number of each item required by a particular surgeon in preparation to perform a particular medical procedure. Because of the large number of different medical procedures and the number of different surgeons having difference preferences, a medical facility may have hundreds or even thousands of surgeon preference cards. Because of the substantial number of surgeon preference cards, the task of maintaining the surgeon preference cards up-to-date as the surgeons' preferences change and/or as the supplies required for different medical procedures change can quickly become onerous and impose a significant drain upon nursing resources. Moreover, the process of updating the surgeon preference cards may also be prone to errors due, at least, to the number of different surgeon preference cards and the number of different types of supplies included on each surgeon preference card. If not updated or if not updated properly, the out-of-date preference cards may undesirably increase the time and effort expended by a surgical nurse during a surgical procedure to locate additional supplies and following a surgical procedure to return supplies that were not actually required.

It would therefore be desirable to provide an improved technique for providing the correct type and number of supplies prior to a medical procedure based upon the requirements imposed by a particular surgeon for the respective medical procedure. In addition, it would be desirable to provide an improved mechanism for updating surgeon preference cards or similar records in order to maintain the surgeon preference cards up-to-date without imposing a significant drain upon critical nursing resources and while reducing the likelihood of errors that may otherwise be occasioned through the updating process.

### BRIEF SUMMARY OF THE INVENTION

A method, apparatus and computer program product are therefore provided in accordance with certain embodiments of the invention to address at least some of the deficiencies of more conventional approaches for updating surgeon preference cards. As such, surgeon preference cards or other comparable records that identify the quantity of each item to be supplied in preparation for a medical procedure may be updated in a manner that requires less time and effort by the nursing staff and in a manner that is less susceptible to errors. For example, the method, apparatus and computer program product may adjust the quantity of an item supplied in preparation for a medical procedure in an at least partially automated fashion.

In accordance with one aspect of the present invention, a method, apparatus and computer program product are provided for adjusting the quantity of an item supplied in preparation for a medical procedure, such as a surgical procedure performed by a particular surgeon, in which one or more instances are identified in which the quantity of the item utilized during the medical procedure differed from the predefined quantity of the item supplied in preparation for the medical procedure. Based upon the instance(s) that have been identified in which a different quantity of the item has been utilized, a suggested adjustment to the predefined quantity of the items supplied in preparation for the medical procedure is determined. A recommendation can then be provided that the predefined quantity of the item supplied in preparation for the medical procedure be altered in accordance with the suggested adjustment. Based on user input in response to the recommendation, the predefined quantity of the item supplied in preparation for the medical procedure may be altered. In this embodiment, a user remains in the decision making process with recommendations being automatically generated in order to reduce the effort required to be expended by the user in order to update a surgeon preference card or other similar record, but with the user required to approve any such recommendation prior to any alteration of the surgeon preference card.

In another aspect of the present invention, a method, apparatus and computer program product are provided for adjusting the quantity of an item supplied in preparation for a medical procedure by determining the quantity of the item that was utilized during one or more instances of a medical procedure. The quantity of the item that was utilized most frequently during the one or more instances of the medical procedure is then compared to a predefined quantity of the item that is otherwise supplied in preparation for the medical procedure. An adjustment to the predefined quantity of the item supplied in preparation for the medical procedure is then determined if the quantity of the item that was utilized most frequently during one or more instances of the medical procedure differed from the predefined quantity of the item supplied in preparation for the medical procedure. As noted above, the adjustment that is determined based upon the foregoing comparison may serve as a suggested adjustment that may be recommended with subsequent alteration of the predefined quantity of the item that is supplied in preparation for the medical procedure being contingent upon user input in response to the recommendation.

In one embodiment, a percentage of the instances of the medical procedure in which the quantity of the item utilized during the medical procedure differed from the predefined quantity of the item is determined. This percentage may then be compared to a predefined threshold with the determination of any adjustment to the predefined quantity of the items supplied in preparation for the medical procedure being contingent upon the percentage being at least as great as the predefined threshold. In this embodiment, a recommendation to alter the predefined quantity of the items supplied in preparation for the medical procedure will also only be provided in instances in which the percentage is at least as great as the predefined threshold, thereby avoiding any adjustments in which only a nominal or insignificant percentage of the instances of a medical procedure utilized a quantity of an item that was different from the predefined quantity of the item that was supplied in preparation for the medical procedure.

Although described above in the context of a method, other embodiments of the present invention are embodied as an apparatus and/or a computer program product. In this regard, an apparatus according to one embodiment of the present invention includes a memory for storing the predefined quantity of an item supplied in preparation for a medical procedure, and a processor, in communication with the memory, configured to perform the functions set forth above. As to the computer program product, the computer program product includes at least one computer-readable storage medium having computer-readable program code portions stored therein with the computer-readable program code portions including executable portions configured to perform the functions set forth above.

### BRIEF DESCRIPTION OF THE DRAWINGS

Having thus described the invention in general terms, reference will now be made to the accompanying drawings, which are not necessarily drawn to scale, and wherein:

FIGS. 1A and 1B are representative examples of surgeon preference cards;

FIG. 2 is a block diagram of an apparatus in accordance with an exemplary embodiment of the present invention;

FIG. 3 is a flow chart of the operations performed in accordance with an exemplary embodiment of the present invention;

FIG. 4 provides data representative of the actual usage of various items during the performance of a medical procedure by a particular surgeon for comparison to the predefined quantities of the items set forth by the surgeon preference card of FIG. 1A in accordance with exemplary embodiments of the present invention and

FIGS. 5A-5C are a series of screen shots with which a user may interact in accordance with one embodiment of the present invention in order to identify if one or more surgeon preference cards are to be updated.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

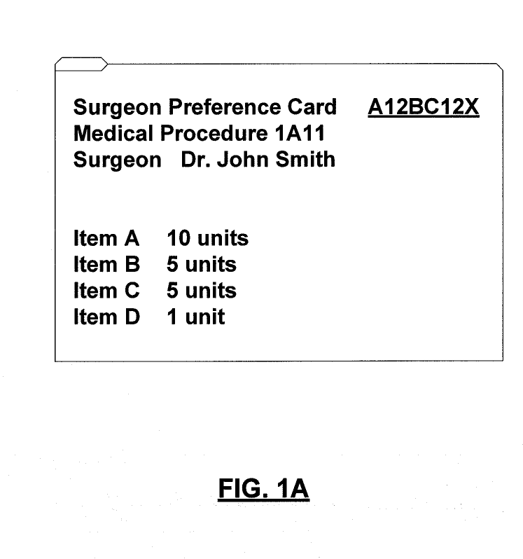

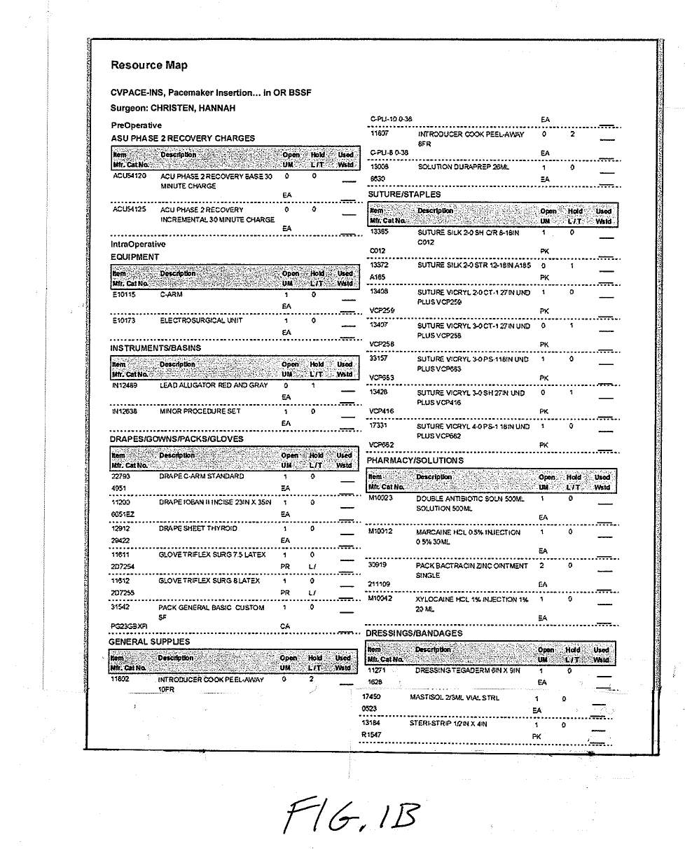

Referring now to FIG. 1A, a surgeon preference card is depicted. As shown, the surgeon preference card identifies the items required to be supplied in preparation for a particular medical procedure to be performed by a particular surgeon. In addition to an identification of each item, such as by item number, name, size and the like, the quantity required of each item is identified by the surgeon preference card. Additionally, each surgeon preference card generally identifies the surgeon and the medical procedure, such as the surgical procedure, for which the surgeon preference card is associated. The surgeon preference card can also include an identifier, such as an alphanumeric identification to facilitate identification of the surgeon preference card.

With respect to the exemplary surgeon preference card of FIG. 1A, the supplies required by Dr. John Smith in conjunction with the performance of a surgical procedure identified as 1A11 requires items A, B, C and D in quantities of 10, 5, 5 and 1, respectively. While a relatively simple surgeon preference card designated as A12BC12X is depicted in FIG. 1A for purposes of example, it should be understood that surgeon preference cards frequently include up to a hundred or more different items with varying quantities. As another example of a surgeon preference card having more items, FIG. 1B depicts a surgeon preference card for a pacemaker insertion designated CVPACE-INS to be performed by Dr. Hannah Christen in an operating room designated OR BSSF. In addition to identifying the various items by item number and description, the number of each item to be opened in advance of the procedure and the number to be made available but held in an unopened state are provided under the headings “open” and “hold”. Other information including the unit of measure (U/M), such as each (each), pair (PR), case (CA) and pack (PK), and an indication of whether the item is latex (L) or trackable (T) may also be provided. Finally, an indication of the number of each item that was used and the number of each item that wasted may be provided, typically during or following completion of the procedure.

Moreover, there are often hundreds or thousands of surgeon preference cards maintained by a particular medical facility in light of the different sets of supplies required for different medical procedures and the different sets of supplies required by different surgeons for even the same medical procedures. Additionally, while the type of items and the quantities of each type of item that is required in preparation for a particular medical procedure is depicted to be embodied in FIG. 1A as a surgeon preference card, the same or similar information may be maintained in various other forms or records and the method, apparatus and computer program of embodiments of the present invention are designed to update such information regardless of the form in which the information is maintained.

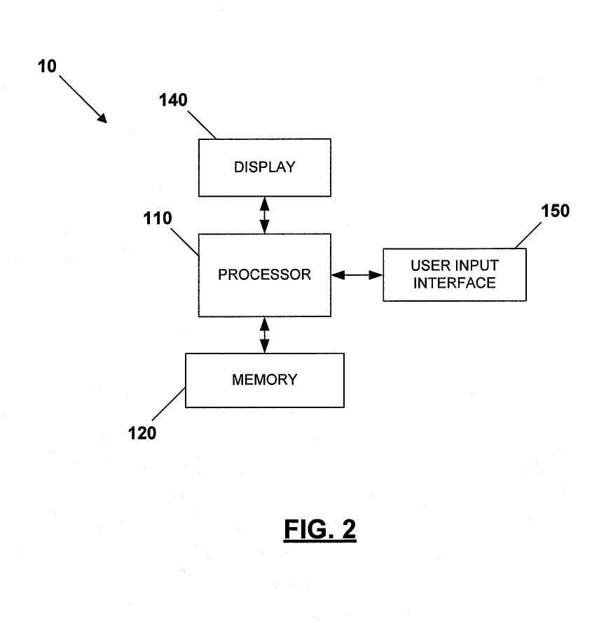

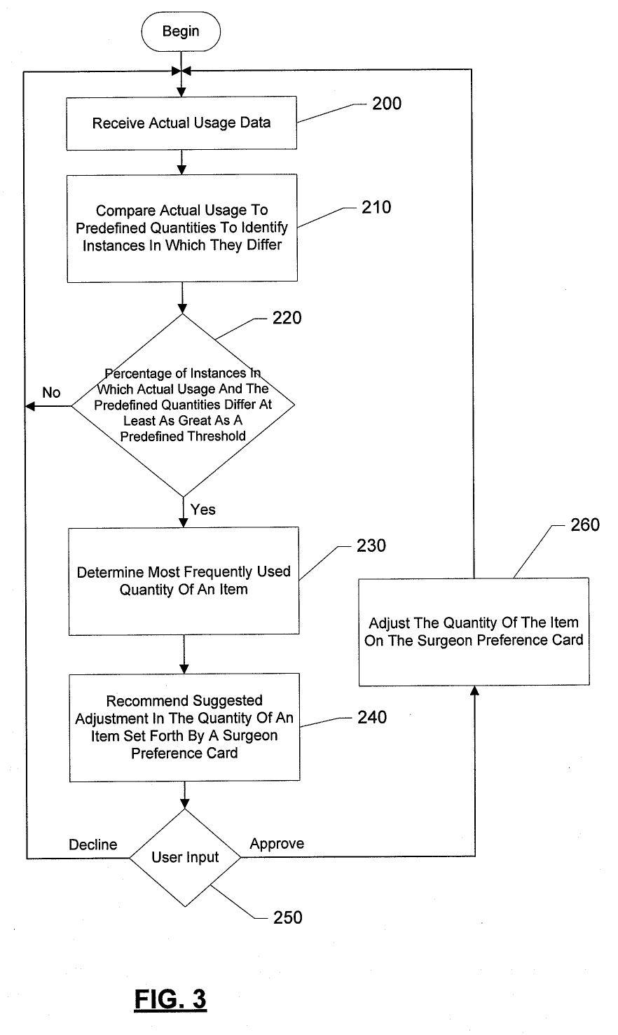

To continue with the example presented by the surgeon preference card of FIG. 1A, the items identified by the surgeon preference card would be collected by a surgical nurse or the like from inventory in advance of, and in preparation for, the performance of the surgical procedure denoted 1A11 by Dr. John Smith. During and following the performance of the medical procedure, a surgical nurse or the like generally tracks and records the actual number of each item that is utilized during the medical procedure. The actual number of each item that is used during the performance of the medical procedure is then provided, such as by a surgical nurse or the like, for further processing in accordance with embodiments of the present invention. As shown in block 200 of the flow chart of FIG. 3, the actual quantity of each item that is used during the performance of the medical procedure may be input into an apparatus 10, such as a computing system, such as depicted in accordance with one exemplary embodiment in FIG. 2.

The apparatus 10 of FIG. 2 includes various means for performing one or more functions in accordance with exemplary embodiments of the present invention, including those more particularly shown and described herein. It should be understood, however, that the apparatus may include alternative means for performing one or more like functions, without departing from the spirit and scope of the present invention. As shown, the apparatus 10 can generally include means, such as a processor 110, connected to a memory 120, for performing or controlling the various functions of the apparatus. The memory can comprise volatile and/or non-volatile memory, and typically stores content, data or the like. For example, the memory typically stores the surgeon preference cards or other records containing the same or similar data as well as the data reported by a surgical nurse or the like representative of the actual usage of items during the performance of a medical procedure. Also for example, the memory typically stores software applications, instructions or the like for the processor to perform steps associated with operation of the apparatus in accordance with embodiments of the present invention.

In addition to the memory 120, the processor 110 can also be connected to at least one interface or other means for displaying, transmitting and/or receiving data, content or the like. In this regard, the interface(s) can include at least one user interface that can include a display 140 and/or a user input interface 150. The user input interface, in turn, can comprise any of a number of devices allowing the entity to receive data from a user, such as a keypad, a touch display, a joystick or other input device. As discussed above, in one exemplary embodiment, the user interface 150, such as a keypad or touch display, may be used by a surgical nurse to directly input into the apparatus 10 data relating to the actual usage of items during the performance of a medical procedure.

If desired, the apparatus 10 of FIG. 2 may be distributed, such as across a network. For example, the user input interface 150 may be embodied by a personal computer or other computer workstation that permits data representative of the actual usage of various items during the medical procedure to be input by or on behalf of a surgical nurse. The personal computer or other computer workstation can be connected across a network with the processor 110, which may be embodied as a server or other computing device. The processor, in turn, communicates with a memory 120, such as a database that may be co-located with the processor or remote therefrom, in order to store the data representative of the actual usage of the various items during the medical procedure and to retrieve the predefined quantities of the items identified by a surgeon preference card or the like. In this embodiment, the display 140 can also be embodied by a personal computer or computer workstation that may be remote from the processor, but in communication therewith across a network to provide feedback, e.g., recommendations, to a surgical nurse or others regarding suggested adjustments to the surgeon preference card or similar record, as discussed hereinafter.

As noted above, the actual usage of items during the performance of a medical procedure is input into the apparatus 10 by or on behalf of a surgical nurse. See block 200 of FIG. 3. This data, reflective of the actual usage of various items during the performance of a medical procedure, is associated with a particular medical procedure and a particular surgeon who has performed the medical procedure. For example, an identification of the medical procedure and of the surgeon may be entered by or on behalf of the surgical nurse, along with the data reflective of the actual usage of various items during the performance of the medical procedure. Alternatively, the data reflective of the actual usage of the various items during the performance of the medical procedure may be associated with a particular surgeon preference card, such as by means of entry of the unique identifier associated with the surgeon preference card.

Thereafter, the method and apparatus of embodiments of the present invention determine the relationship of the actual usage of various items during the performance of a particular medical procedure by a particular surgeon to the predefined quantities of the various items identified by the surgeon preference card or otherwise identified in advance of the medical procedure, such as by comparing the actual usage to the predefined quantities as shown in block 210 of FIG. 3. For a particular surgeon preference card or other comparable record identifying the quantity of various items to be supplied in preparation for a medical procedure to be performed by a respective surgeon, the quantity of each item that was actually used during performance of the medical procedure by the particular surgeon is compared to the predefined quantity of the corresponding item that is set forth by the surgeon preference card or other like record.

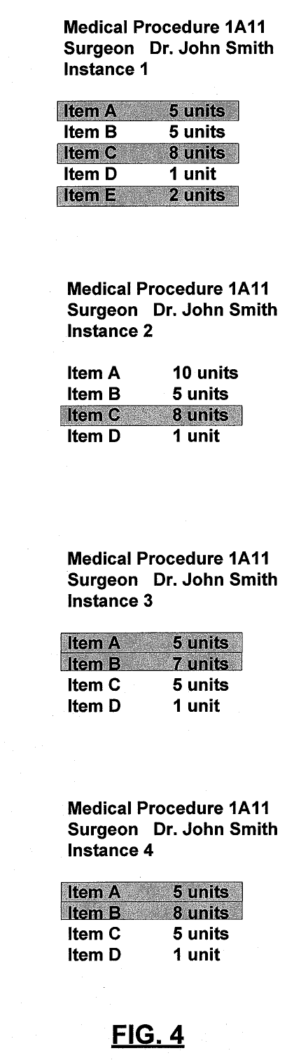

With reference to the example depicted in FIG. 4 in which Dr. John Smith performed four instances of the medical procedure designed 1A11, the data reflective of the actual usage of the various items during performance of each instance of the medical procedure by Dr. John Smith is compared to the predefined quantities of the items set forth by the surgeon preference card for Dr. John Smith's performance of medical procedure 1A11, as shown in FIG. 1A. As reflected in FIG. 4, during the first, third and fourth instances in which Dr. John Smith performed medical procedure 1A11, five units of Item A were utilized in comparison to the predefined quantity of ten units for Item A. In only the second instance in which surgeon John Smith performed medical procedure 1A11 did Dr. John Smith utilize the same number of Item A, that is, ten units, as was predefined by the respective surgeon preference card. For purposes of illustration, it is noted that the actual usage data that varies from the predefined quantities set forth by the surgeon preference card of FIG. 1A are shaded in FIG. 4.

Similar comparisons would generally be performed for the other items identified in the surgeon preference card for the respective medical procedure, as well as for any other items actually utilized during the performance of the medical procedures that were not identified by the surgeon preference card or similar record. In this regard, one unit of Item E was utilized during the first instance in which Dr. John Smith performed medical procedure 1A11, but Item E was not identified by the surgeon preference card. As such, the method and apparatus of one embodiment of the claimed invention still compares the data reflective of the actual usage of Item E to the predefined quantity of Item E defined by the surgeon preference card or similar record with the predefined quantity of Item E being zero since Item E was not included in the respective surgeon preference card.

Although not necessary for all embodiments of the present invention, the method and apparatus of one exemplary embodiment then determines the percent of instances of the respective medical procedure in which the actual usage of a respective item varied from the predefined quantity of the same item that is established by the surgeon preference card or similar record. As shown in block 220 of FIG. 3, if the percent of instances in which the actual usage varies from that defined by the surgeon preference card for a respective item equals or exceeds the predefined threshold, the item is flagged to be subjected to further analysis, as set forth below. By comparing the percent of instances in which an actual variance in the quantity of an item is identified to a predefined threshold, the method and apparatus can be configured by the operator to only suggest adjustments in the quantity of those items for which the actual usage more frequently differs from the predefined quantities identified by the surgeon preference card and, therefore, avoid suggesting any adjustments that may later prove to be incorrect or transitory for those items for which the actual usage only rarely varies from the predefined quantity identified by the surgeon preference card. In the above example, the predefined threshold may be set to 33% such that the single instance in which one unit of Item E was utilized during Dr. John Smith's performance of medical procedure 1A11 will not be considered to be a sufficiently frequent variation from the surgeon preference card to warrant any suggested adjustment to the surgeon preference card, thereby avoiding suggesting any adjustments for such an infrequent occurrence.

In embodiments in which either the percent of instances in which the actual usage of an item varies from the predefined quantity defined by the surgeon preference card by at least a predefined percentage or in embodiments that do not impose such a requirement, the method and apparatus determines the quantity of the item that was actually used in each instance of the medical procedure. In one advantageous embodiment, the quantity of an item that was actually used most frequently is determined, as opposed to the average or mean of the data reflective of the actual usage of the item during the performance of the medical procedure. See block 230 of FIG. 3. In this embodiment, the quantity of the item that is actually used most frequently is identified so that the surgeon preference card or similar record can be reconfigured to identify the proper quantity on the largest number of occasions, as opposed to defining a quantity that is close to the actual usage, but still differs somewhat from the actual usage as may result from use of the average or mean of the data reflective of the actual usage of the respective item.

Returning to the example provided by FIG. 4, five units of Item A were actually used during three of the four instances of medical procedure 1A11 with ten units of Item A being during the other instance of the same medical procedure. Since the most frequently used quantity, five units, differs from the predefined quantity, ten units, set forth by the surgeon preference card, a suggested adjustment to the surgeon preference card may be made as discussed below. Alternatively, if the most frequently used quantity of an item was the predefined quantity set forth by the surgeon preference card, the method and apparatus of this exemplary embodiment would not suggest any adjustment to the quantity of the item even though some different quantity of the item was used during another instance of the medical procedure (since this different quantity is not the most frequently occurring quantity of the item).

In instances in which two different quantities of an item are actually used most frequently, i.e., each quantity is used in the same number of instances, the method and apparatus may be configured to identify the greater quantity as the quantity that occurred most frequently for purposes of determining if an adjustment is to be suggested. By selecting the greater quantity, the method and apparatus of this embodiment reduce the likelihood that a surgeon will require additional units of the item during performance of the medical procedure. Alternatively, the method and apparatus may select the greater quantity as the quantity that occurs most frequently as described above unless one of the quantities that occurs most frequently is the predefined quantity set forth by the surgeon preference card in which case the predefined quantity is considered to have occurred most frequently, thereby avoiding marginal adjustments to the surgeon preference card. In regards to the exemplary actual usage data set forth by FIG. 4, eight units of Item C are used in two instances and five units of Item C are used in two instances. Since the surgeon preference card in this example sets forth a predefined quantity of Item C of five, the method and apparatus of one embodiment would not suggest an adjustment as described above.

Although the method and apparatus of one embodiment could automatically revise the surgeon preference card or similar record to change the predefined quantity of the respective item to the quantity of the item that was actually used most frequently, the method and apparatus of one advantageous embodiment suggests or recommends such an adjustment to the user with the value of the suggested adjustment generally being the quantity of the respective item that was actually used most frequently during the instances of the medical procedure that are under consideration. See block 240 of FIG. 3. For example, the apparatus 10 of FIG. 2 and, in particular, the processor 110 can drive the display 140 to provide a visual recommendation that the surgeon preference card be altered to redefine the quantity of the respective item to be the quantity that has been determined to have been actually used most frequently. As shown in decision block 250 of FIG. 3, the user can then approve such a suggested adjustment to the surgeon preference card or decline to make such an adjustment to the surgeon preference card or could defer the decision to some later time. In instances in which the user approves the update to the surgeon preference card, the method and apparatus alters the surgeon preference card or similar record such that the predefined quantity of the respective item is changed to be that quantity that was determined to have been used most frequently during the instances of the medical procedure that are under consideration. See block 260 of FIG. 2. As such, the resulting surgeon preference cards can be more reflective of the patterns of actual usage by a particular surgeon during the performance of the respective medical procedure, thereby increasing the likelihood that the desired quantity of each item will have been supplied in preparation for the medical procedure without unnecessarily supplying excessive quantities of any one item. Alternatively, in instances in which the user declines to make such an adjustment, the method and apparatus may require the medical procedure to be performed by the particular surgeon a predetermined number of times before again suggesting that the quantity of the same item be adjusted, thereby avoiding frequent recommendations for an adjustment to the same item that are repeatedly declined by the user.

The method described above and depicted generally in FIG. 3 is subject to many variations without departing from the spirit and scope of the present invention. For example, the forgoing method can be performed on a per-surgeon preference card basis such that each item identified on a respective surgeon preference card or actually utilized by the surgeon during the performance of the medical procedure is analyzed, and a recommendation is provided to a user as to the suggested adjustment(s) to one or more of the items identified by the surgeon preference card at one time. Alternatively, the method can be performed on a pre-item basis such that the actual usage of the item during the performance of various medical procedures by various surgeons is analyzed prior to analyzing the patterns of actual usage of another item, again during the performance of various medical procedures by various surgeons.

Still further, the method described above and set forth generally in FIG. 3 can be performed following the input of data reflective of the actual usage of the various items during the performance of each medical procedure or, more typically, at predefined time intervals, such as once a day, once every two or three days, once a week or the like so that a number of instances of at least some of the medical procedures will have been performed so as to render the data reflective of the actual usage of the various items during the performance of the respective medical procedures more useful. Still further, the method and apparatus of the present invention can review the data reflective of the actual usage of the items during the performance of a medical procedure over any time period in the past, such as those medical procedures performed within the last week, within the last month, within the last year or the like. The time period over which the data reflective of the actual usage of the various items during the performance of a medical procedure that is considered may differ, depending upon the medical procedure and, in some instances, depending upon the surgeon with those medical procedures that are performed more frequently by a particular surgeon generally requiring a shorter window of time in which to gather a meaningful collection of data reflective of the actual usage of the various items than those medical procedures that are performed more rarely by a particular surgeon.

As noted above, the method and apparatus not only compares the data reflective of the actual usage of items that appear on the surgeon preference card to the predefined quantities of those same items set forth on the surgeon preference card, but also identify the actual usage of any items during the performance of a medical procedure that are not identified by the surgeon preference card for the respective medical procedure. Thus, the method and apparatus can make a recommendation that a certain number of the item(s) that were not previously identified by the surgeon preference card be added to the surgeon preference card if the data reflective of the actual usage of that item indicates that a non-zero quantity of that item is actually required most frequently, that is, quantity X is used more frequently during the performance of a medical procedure than instances in which the item is not used at all.

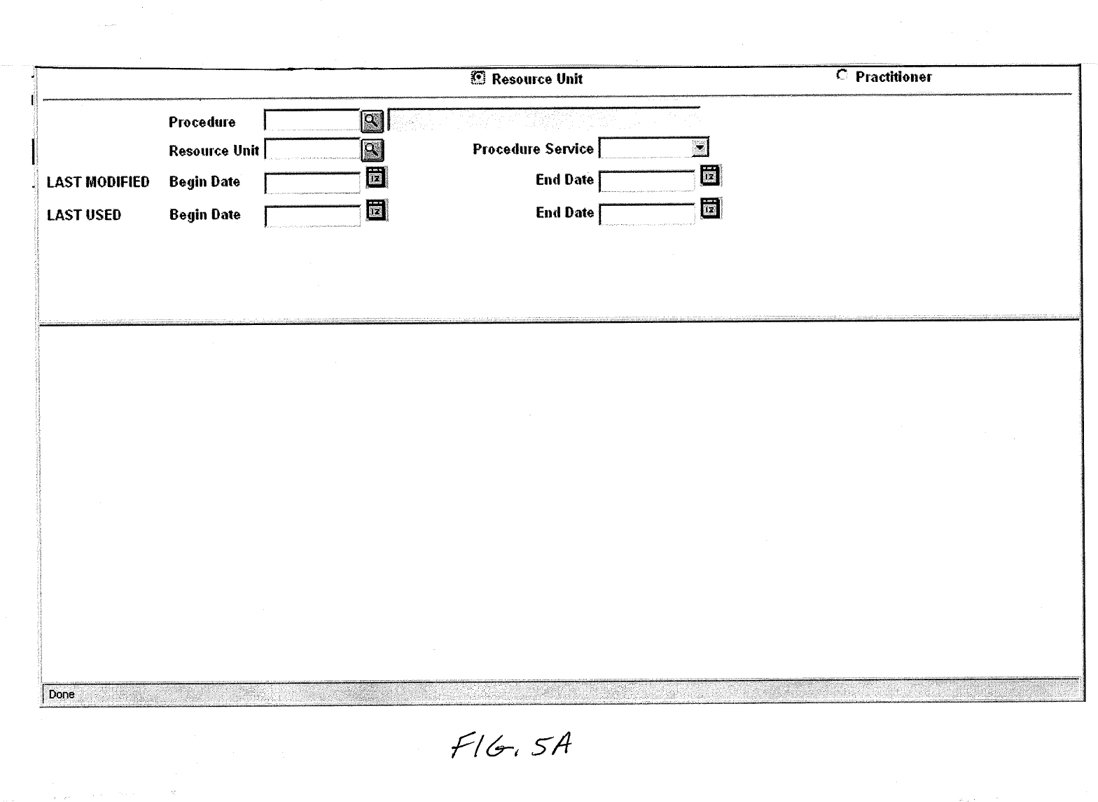

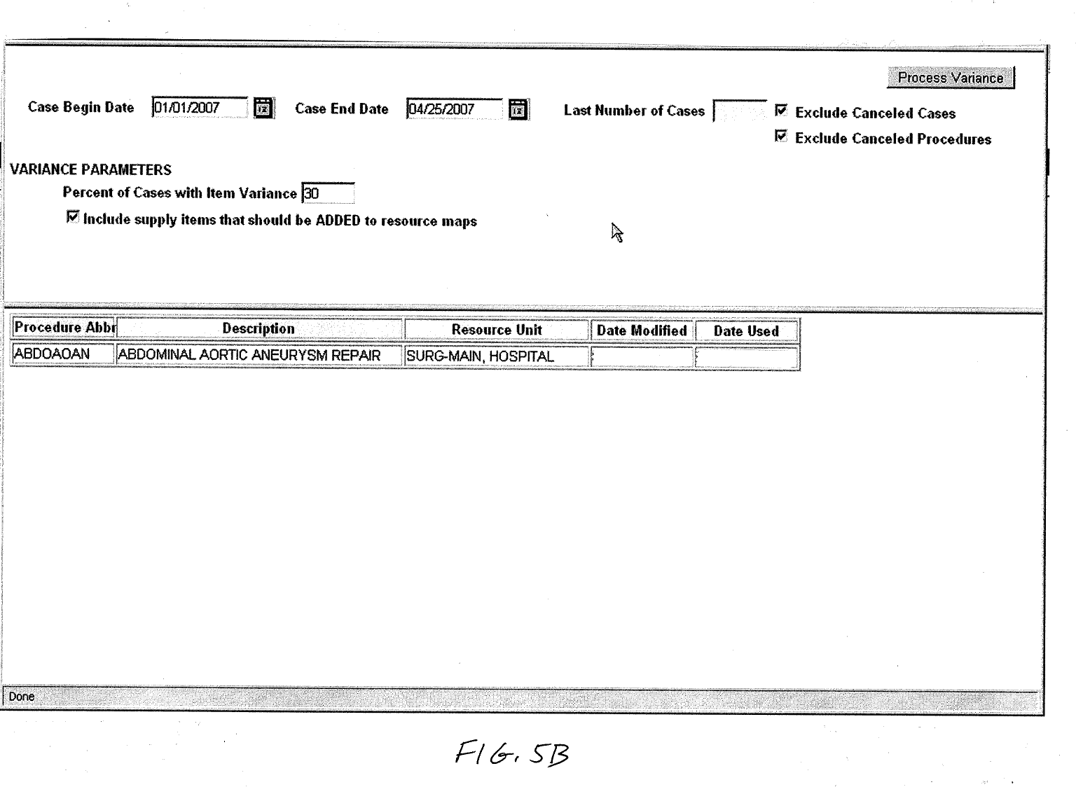

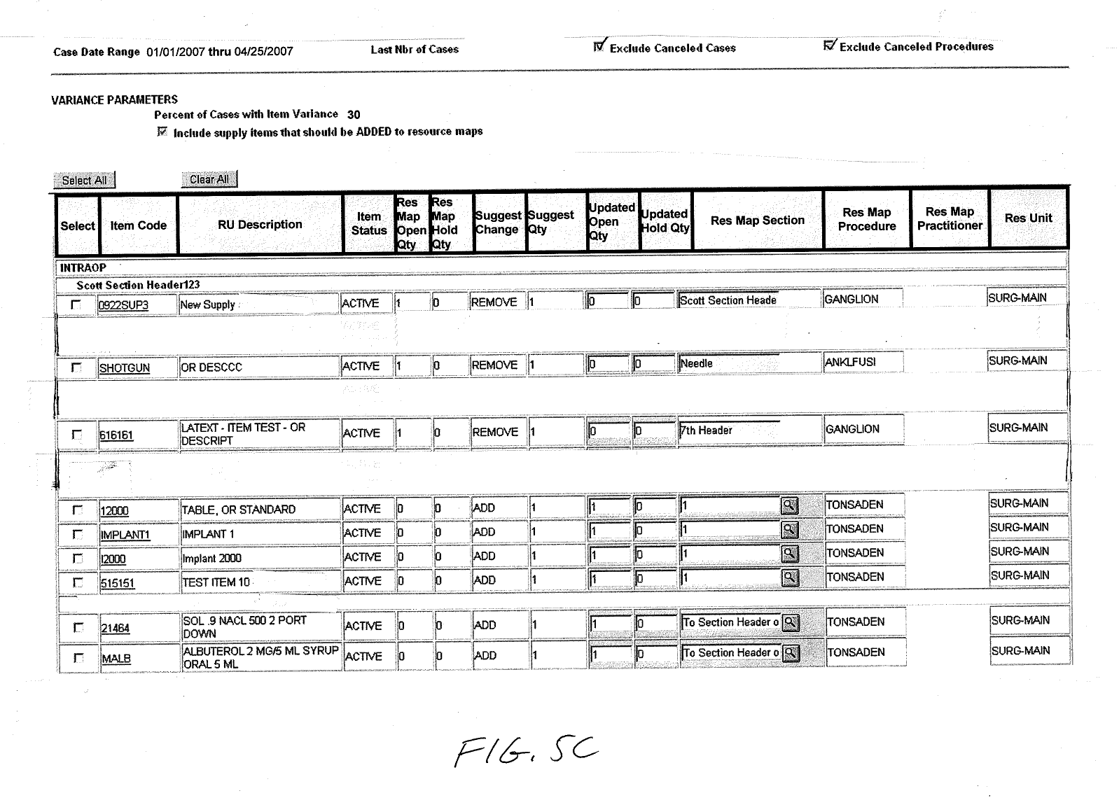

To provide a further example, a series of screen shots are depicted in FIGS. 5A-5C. These screen shots may be provided by a display, such as display 140, in response to direction from a processor, such as processor 110, and a user may interact with the display, such as via user input interface 150, in order to identify if one or more surgeon preference cards are to be updated. As shown in FIG. 5A, for example, a user can define the breadth of the procedures that are to be considered for purposes of comparing actual usage to that defined by the surgeon preference cards, such as a particular type of procedure performed in a particular resource unit, i.e., operating room facility, and/or by a particular surgeon. Additionally, a user can bound the surgeon preference cards that are considered, such as based upon the last time that the surgeon preference cards were modified or used. Based on input provided via the display of FIG. 5A, FIG. 5B, FIG. 5B shows that a user identified the procedures of interest a ABDOAOAN procedures, i.e., an abdominal aortic aneurysm repairs, performed in Surg-Main, Hospital. In response to the display of FIG. 5B, the user can then define a window of time during which the procedure would have had to have been performed to be considered, namely, between Jan. 1, 2007 and Apr. 25, 2007. Alternatively, the display of FIG. 5B permits a user to define the procedures to be considered by number, such as the most recent 5 or 10 instances of the procedure, as opposed to a date range. Further, a user can elect to exclude cancellations, such as canceled procedures, that may otherwise skew the results. As also noted in FIG. 5B, the user is able to identify the predefined threshold, above which deviations will be analyzed more completely as described above.

The suggested adjustments of this example are then shown in FIG. 5C. In this regard, the items are identified by a code and a description. For example, it is recommended that the items denoted as 0922SUP3, SHOTGUN and 616161 be removed from the surgeon preference cards for ganglion, ankle fusion and ganglion procedures, respectively. In both instances, the surgeon preference cards had previously indicated that one unit of the respective item was to be provided and opened. The exemplary recommendations shown in FIG. 5C also suggest adding several items, e.g., a standard table, implant 1, implant 2000, test item 10 and several medications, to the tonsil/adenode procedure. As noted above, the user can then decide whether or not to alter the surgeon preference cards in the manner suggested by checking the box or not beside each item.

By automating the analysis and recommendation process, the method and apparatus of embodiments of the present invention substantially reduce the time required to update surgeon preference cards or similar records based upon historical information relating to the actual usage of items during the performance of a medical procedure, thereby reducing the drain on critical nursing resources. Similarly, the automation of the analysis and recommendation process may reduce the number of errors that occur during the updating process. By only suggesting adjustments to items having actual usage data that varies from the predefined quantity identified by the surgeon preference card that occur more than a predefined percentage of the instances of the medical procedure, the method and apparatus of this embodiment advantageously only makes recommendations for suggested adjustments in those instances in which the actual usage more frequently varies form the predefined quantity identified by the surgeon preference card than in those instances in which the actual usage only rarely varies from the predefined quantity of the item identified by the surgeon preference card. Additionally, by basing the suggested adjustment in at least some embodiments upon the quantity of the item that was used most frequently, the updated surgeon preference card or similar record will identify quantities of the various items to be supplied in preparation for the medical procedure that are correct in as many instances as possible, thereby ensuring that as many medical procedures as possible proceed smoothly and efficiently and assisting with the control of inventory by providing better projections as to the usage of various items and avoiding unnecessary withdrawal and return of items to inventory.

As described above and as will be appreciated by one skilled in the art, embodiments of the present invention may be configured as a method or apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatus and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a memory for storing a predefined quantity of an item supplied in preparation for a medical procedure; and
a processor, in communication with the memory, configured to identify one or more instances in which the quantity of the item utilized during the medical procedure differed from the predefined quantity of the item stored by the memory, the processor also configured to determine a suggested adjustment to the predefined quantity of the item based upon the one or more instances that have been identified in which a different quantity of the item has been utilized, the processor further configured to provide a recommendation that the predefined quantity of the item be altered in accordance with the suggested adjustment.

2. An apparatus according to claim 1 wherein the processor is further configured to alter the predefined quantity of the item supplied in preparation for the medical procedure and stored in the memory based upon user input in response to the recommendation.

3. An apparatus according to claim 1 wherein the processor is configured to determine a percentage of the instances of the medical procedure in which the quantity of the item utilized during the medical procedure differed from the predefined quantity of the item and is further configured to determine the suggested adjustment and to provide the recommendation only if the percentage is at least as great as a predefined threshold.

4. An apparatus according to claim 1 wherein the processor is also configured to determine the quantity of the item that was utilized during one or more instances of the medical procedure and to compare the quantity of the item that was utilized most frequently during the one or more instances of the medical procedure to the predefined quantity of the item supplied in preparation for the medical procedure, and wherein the processor is further configured to determine the suggested adjustment to the predefined quantity of the item supplied in preparation for the medical procedure if the quantity of the item that was utilized most frequently during the one or more instances of the medical procedure differed from the predefined quantity of the item supplied in preparation for the medical procedure.

5. An apparatus according to claim 1 wherein the medical procedure comprises
a surgical procedure performed by a respective surgeon.

6. A method of adjusting a quantity of an item supplied in preparation for a medical procedure, the method comprising:
identifying one or more instances in which the quantity of the item utilized during the medical procedure differed from a predefined quantity of the item supplied in preparation for the medical procedure;
determining a suggested adjustment to the predefined quantity of the item supplied in preparation for the medical procedure based upon the one or more instances that have been identified in which a different quantity of the item has been utilized; and
providing a recommendation that the predefined quantity of the item supplied in preparation for the medical procedure be altered in accordance with the suggested adjustment.

7. A method according to claim 6 further comprising altering the predefined quantity of the item supplied in preparation for the medical procedure based upon user input in response to the recommendation.

8. A method according to claim 6 wherein identifying one or more instances in which the quantity of the item utilized during the medical procedure differed from the predefined quantity of the item comprises determining a percentage of the instances of the medical procedure in which the quantity of the item utilized during the medical procedure differed from the predefined quantity of the item, and wherein determining the suggested adjustment and providing the recommendation are contingent upon the percentage being at least as great as a predefined threshold.

9. A method according to claim 6 further comprising:
determining the quantity of the item that was utilized during one or more instances of the medical procedure; and
comparing the quantity of the item that was utilized most frequently during the one or more instances of the medical procedure to the predefined quantity of the item supplied in preparation for the medical procedure,
wherein determining a suggested adjustment comprises determining a suggested adjustment to the predefined quantity of the item supplied in preparation for the medical procedure if the quantity of the item that was utilized most frequently during the one or more instances of the medical procedure differed from the predefined quantity of the item supplied in preparation for the medical procedure.

10. A method according to claim 6 wherein the medical procedure comprises a surgical procedure performed by a respective surgeon.

11. A computer program product for adjusting a quantity of an item supplied in preparation for a medical procedure, wherein the computer program product comprises at least one computer-readable storage medium having computer-readable program code portions stored therein, the computer-readable program code portions comprising
a first executable portion configured to identify one or more instances in which the quantity of the item utilized during the medical procedure differed from a predefined quantity of the item supplied in preparation for the medical procedure;
a second executable portion configured to determine a suggested adjustment to the predefined quantity of the item supplied in preparation for the medical procedure based upon the one or more instances that have been identified in which a different quantity of the item has been utilized; and
a third executable portion configured to provide a recommendation that the predefined quantity of the item supplied in preparation for the medical procedure be altered in accordance with the suggested adjustment.

12. A computer program product according to claim 11 further comprising an executable portion configured to alter the predefined quantity of the item supplied in preparation for the medical procedure based upon user input in response to the recommendation.

13. A computer program product according to claim 11 wherein the first executable portion is further configured to determine a percentage of the instances of the medical procedure in which the quantity of the item utilized during the medical procedure differed from the predefined quantity of the item, and wherein execution of the second and third executable portions is contingent upon the percentage being at least as great as a predefined threshold.

14. A computer program product according to claim 11 further comprising:
a fourth executable portion configured to determine the quantity of the item that was utilized during one or more instances of the medical procedure; and
a fifth executable portion configured to compare the quantity of the item that was utilized most frequently during the one or more instances of the medical procedure to the predefined quantity of the item supplied in preparation for the medical procedure,
wherein the second executable portion is further configured to determine a suggested adjustment to the predefined quantity of the item supplied in preparation for the medical procedure if the quantity of the item that was utilized most frequently during the one or more instances of the medical procedure differed from the predefined quantity of the item supplied in preparation for the medical procedure.

15. A computer program product according to claim 11 wherein the medical procedure comprises a surgical procedure performed by a respective surgeon.

16. An apparatus comprising:
a memory for storing a predefined quantity of an item supplied in preparation for a medical procedure; and
a processor, in communication with the memory, configured to determine the quantity of the item that was utilized during one or more instances of the medical procedure, the processor also configured to compare the quantity of the item that was utilized most frequently during the one or more instances of the medical procedure to the predefined quantity of the item stored by the memory, the processor further configured to determine an adjustment to the predefined quantity of the item supplied in preparation for the medical procedure if the quantity of the item that was utilized most frequently during the one or more instances of the medical procedure differed from the predefined quantity of the item stored in the memory.

17. An apparatus according to claim 16 wherein the processor is further comprised to provide a recommendation that the predefined quantity of the item supplied in preparation for the medical procedure be altered in accordance with the adjustment.

18. An apparatus according to claim 17 wherein the processor is further configured to alter the predefined quantity of the item supplied in preparation for the medical procedure based upon user input in response to the recommendation.

19. An apparatus according to claim 16 wherein the processor is also configured to determine a percentage of the instances of the medical procedure in which the quantity of the item utilized during the medical procedure differed from the predefined quantity of the item, and wherein the processor is further configured to determine the adjustment only if the percentage is at least as great as a predefined threshold.

20. An apparatus according to claim 16 wherein the medical procedure comprises a surgical procedure performed by a respective surgeon.

21. A method of adjusting a quantity of an item supplied in preparation for a medical procedure, the method comprising:
determining the quantity of the item that was utilized during one or more instances of the medical procedure;
comparing the quantity of the item that was utilized most frequently during the one or more instances of the medical procedure to a predefined quantity of the item supplied in preparation for the medical procedure; and
determining an adjustment to the predefined quantity of the item supplied in preparation for the medical procedure if the quantity of the item that was utilized most frequently during the one or more instances of the medical procedure differed from the predefined quantity of the item supplied in preparation for the medical procedure.

22. A method according to claim 21 further comprising providing a recommendation that the predefined quantity of the item supplied in preparation for the medical procedure be altered in accordance with the adjustment.

23. A method according to claim 22 further comprising altering the predefined quantity of the item supplied in preparation for the medical procedure based upon user input in response to the recommendation.

24. A method according to claim 21 further comprising determining a percentage of the instances of the medical procedure in which the quantity of the item utilized during the medical procedure differed from the predefined quantity of the item, and wherein determining the adjustment is contingent upon the percentage being at least as great as a predefined threshold.

25. A method according to claim 21 wherein the medical procedure comprises a surgical procedure performed by a respective surgeon.

26. A computer program product for adjusting a quantity of an item supplied in preparation for a medical procedure, wherein the computer program product comprises at least one computer-readable storage medium having computer-readable program code portions stored therein, the computer-readable program code portions comprising
a first executable portion configured to determine the quantity of the item that was utilized during one or more instances of the medical procedure;
a second executable portion configured to compare the quantity of the item that was utilized most frequently during the one or more instances of the medical procedure to a predefined quantity of the item supplied in preparation for the medical procedure; and
a third executable portion configured to determine an adjustment to the predefined quantity of the item supplied in preparation for the medical procedure if the quantity of the item that was utilized most frequently during the one or more instances of the medical procedure differed from the predefined quantity of the item supplied in preparation for the medical procedure.

27. A computer program product according to claim 26 further comprising a fourth executable portion configured to provide a recommendation that the predefined quantity of the item supplied in preparation for the medical procedure be altered in accordance with the adjustment.

28. A computer program product according to claim 27 further comprising a fifth executable portion configured to alter the predefined quantity of the item supplied in preparation for the medical procedure based upon user input in response to the recommendation.

29. A computer program product according to claim 26 further comprising an executable portion configured to determine a percentage of the instances of the medical procedure in which the quantity of the item utilized during the medical procedure differed from the predefined quantity of the item, and wherein execution of the third executable portion is contingent upon the percentage being at least as great as a predefined threshold.

30. A computer program product according to claim 26 wherein the medical procedure comprises a surgical procedure performed by a respective surgeon.
